(19) United States
(12) Patent Application Publication
(10) Pub. No.: US 2015/0061355 A1
(43) Pub. Date: Mar. 5, 2015

(54) Method for Producing Chassis Components for Commercial Vehicles by Means of Friction Welding, and Corresponding Axle Unit

(71) Applicant: Matthias Hoppe, Muhlheim am Main (DE)

(72) Inventor: Matthias Hoppe, Muhlheim am Main (DE)

(73) Assignee: SAF-HOLLAND, GMBH

(21) Appl. No.: 14/233,841

(22) PCT Filed: Jul. 13, 2012
(86) PCT No.: PCT/EP2012/063760

§ 371 Date: Sep. 3, 2014

(30) Foreign Application Priority Data
Jul. 26, 2011 (DE) 10 2011 079 799.8

(51) Int. Cl. B23K 20/12; B60B 35/00

(52) U.S. Cl. CPC B23K 20/129; B60B 35/00; B60B 2310/3025
USPC 301/124.1; 228/114.5

(57) ABSTRACT

The invention relates to a method for producing chassis components for commercial vehicles, comprising the following steps: providing a first element and a second element, wherein the first element has a first contact region, in which it is designed essentially rotationally symmetrically about a rotational axis, and wherein the second element has a second contact region, which is curved and arranged opposite the first contact region; causing one of the elements to rotate about the rotational axis relative to the respective other element; pressing the elements against one another such as to generate friction between the second contact region and the first contact region and partial melting in the first and second contact regions; delaying the rotation of the elements relative to one another, wherein the partially melted regions transition into the solid state and a bonded connection is established between the first element and the second element.

### BACKGROUND OF THE INVENTION

The present invention relates to a method for producing chassis components for commercial vehicles and an axle unit produced using said method.

In the methods known from the state of the art, elements enclosing a cylinder-shaped surface are permanently fixed to one another by substance-to-substance bonds, mainly using known welding techniques such as gas welding or electric-arc welding. A disadvantage hereof is the in most cases selected heat input, which leads to dangerous thermal stresses in the material. From the state of the art, there are further known various friction welding methods, wherein a cylinder-shaped body is widened by means of a wedge or cone during friction welding and the element to be mounted is friction-welded at the widened portion of the cylindrical body. The disadvantage of said method is that, on the one hand, the cylindrical body has to be deformed and, on the other hand, widening the cylindrical body is only possible in the case of small wall thicknesses.

Therefore, the object of the present invention is to provide a method for producing chassis components, in which a bonded connection may be established between various elements, irrespective or their wall thicknesses.

### SUMMARY OF THE INVENTION

According to the invention, the method for producing chassis components for commercial vehicles comprises the following steps: providing a first element or component and a second element or component, wherein the first element has a first contact region, in which it is designed essentially rotationally symmetrically about a rotational axis, and wherein the second element has a second contact region, which is curved and arranged opposite the first contact region; causing one of the elements to rotate about the rotational axis relative to the respective other element; pressing the elements against one another such as to generate friction between the second contact region and the first contact region and partial melting in the first and second contact regions; and delaying the rotation of the elements relative to one another, wherein the partially melted regions transition into the solid state and a bonded connection is established between the first element and the second element. In a first method step, a first element and a second element are provided, wherein each element comprises a contact region and wherein the first element in its first contact region is designed essentially rotationally symmetrically about a rotational axis. Preferably, the first element is the axle of a commercial vehicle, wherein said axle has its largest extent along the rotational axis and preferably comprises one or more first contact regions designed rotationally symmetrically about said rotational axis. The second element comprises a second contact region which is curved and arranged opposite the first contact region such that the axis about which the second contact region essentially curves points in the direction of the first contact region. To put it differently, the second contact region is arranged such that its curved side or surface at least partially encloses the first contact region. According to the invention, the two elements are made to rotate relative to one another about the rotational axis. It is preferred to cause only the first element to rotate and to maintain the second element stationary. In particular if the first element is particularly heavy or particularly large or has a complex geometry, which is difficult to cause to rotate, it may also be preferred that the second element rotates about the first element, wherein the first element remains stationary. The speed of rotation of the two elements relative to one another, together with the compressive force or contact force acting later between the elements, which, in turn, causes a compressive force between the two contact regions of the elements, provides or determines the temperature generated between the first and second contact regions, which, in turn, leads to a partial melting of the material of the first and/or second element(s). Here, the speed of rotation may not be too fast so as not to cause excessive friction and, thus, excessive temperature, which, in turn, may lead to a disturbed structure or, for example, scaling of alloying elements such as carbon, or excessive partial melting of the material of the first and second elements. It is preferred that at least the material of one of the elements transitions into a doughy or plastic state. After the elements have been caused to rotate relative to one another and the desired speed of rotation has been reached, the components are displaced towards each other and pressed against one another. Here, the first contact region comes into contact with the second contact region and there is friction between the two contact regions since they are displaced relative to one another due to the rotation of the elements. In the areas of the contact regions in which friction occurs, the kinetic energy of the first and second elements relative to one another is transformed into thermal energy, wherein said input of thermal energy leads to an increase in the temperature in the material of the two contact regions and of the two elements, respectively. Preferably, the increase in temperature is so great that partial melting occurs, i.e. that the melting temperature of the manufacturing material of one of the elements is reached. If the elements consist of different materials having different melting temperatures, it is in general sufficient if one of the elements, namely that having the lower melting temperature, is partially melted in certain areas and the other one, namely that having the higher melting temperature, only comes into the flow range by reaching the flow temperature since there may nevertheless be established a bonded connection between the partially melted first element and the second element, which has not been partially melted. Thus, friction welding is particularly suitable for welding together elements which are made from different manufacturing materials. After there has been sufficient partial melting between the two contact regions, i.e. the first contact region and the second contact region, the rotation of the elements relative to one another is slowed down, i.e. the relative speed of rotation is reduced. Here, it is preferred that the speed of rotation reaches the value 0, i.e. that the two elements no longer move relative to one another, in the position in which the two elements are to be fixed to one another after the method or process has been completed. It may be further preferred to reduce the rotation of the elements relative to one another already at the moment of first contact between the first and second contact regions and to successively decrease it already while partial melting occurs between the two contact regions. A preferred example for this is inertia friction welding, where both elements are brought to a certain speed relative to one another and a certain kinetic energy is available by means of flywheel masses fastened to the first and/or second element(s), which kinetic energy is transformed into thermal energy during friction welding, wherein the rotation is constantly slowed down from the moment of first contact of the two elements, and the kinetic energy is continuously transformed into thermal energy until the kinetic energy has been used up and the two parts have been aligned and welded together in the right position relative to one another. The bonded connection between the first and second elements established by means of the method of the invention is of particularly high quality since material distortion due to temperature stresses is minimized due to the uniform input of heat over the two contact regions. Furthermore, during the first contact of the two elements or of the two contact regions, respectively, relative to one another, possibly disturbing oxide layers on the elements are cut off or rubbed off or ground off and it is possible to achieve a highly uniform structure at the joint surface, with very few disturbing inclusions of foreign matter.

In a preferred embodiment, the first contact region and the second contact region have contact surfaces which before being pressed against one another are aligned such that they lie opposite one another and are designed such that they diverge or converge relative to one another. To put it differently, this means that when the two contact surfaces of the contact regions are aligned such that they lie opposite one another, the distance between the two contact surfaces relative to one another along or across the rotational axis increases and/or decreases. For example, it is preferred that the first contact region at the first element is designed circular and that the second contact region at the second element is also designed circular, wherein, however, the mean radius of the curvature of the second contact region is smaller or larger than the radius of the first contact region. Particularly preferably, the second contact region has a larger mean radius than the first contact region, wherein the contact surfaces of the two contact regions are designed such that they diverge relative to one another so that when the two elements are pressed against one another, at first a central point of the second contact region engages the first contact region. Alternatively preferably, the two contact surfaces may be designed such that they converge towards each other, wherein the second contact region has a smaller mean radius than the first contact region so that when the two elements are pressed against one another, at first two ends of a second element, which is sickle-shaped or crescent-shaped, for example, come into contact with the first contact region. Said converging or diverging design of the contact surfaces of the contact regions is preferred in order to achieve that there is at first only partial melting between the two contact regions over a certain area, and at the same time friction between the two contact regions occurs at first only over a certain area so that the torque or rotational energy or kinetic energy required for the partial melting of the two elements may be kept as low as is possible, wherein the requirements on the manufacturing equipment may be kept low.

In a first preferred embodiment, the elements are pressed against one another across the rotational axis, wherein the second element has a first end and a second end along its circumferential direction. In this preferred embodiment, additional parts may be fixed to the first element eccentrically to the rotational axis, which first element preferably is a vehicle axle or another cylindrical or rotationally symmetrical support body of a chassis suspension of a commercial vehicle, for example. For example, the second element may be a brake carrier. It is also preferred that the second element comprises a first and a second end along its circumferential direction, i.e. along its extension across or essentially across the rotational axis. The second element, in the proximity of the second contact region, is designed as a body in the shape of a preferably annular section or preferably circular section, wherein it may be preferred to design the second contact region as semicircular section or semi-circle annular section in order to be able to move the second element laterally towards the first element so that the two contact regions come into contact with each other. It may be further preferred that the second element or the second contact region almost entirely encompasses the first contact region, wherein the first end and the second end of the second element are spaced apart such that a force may be applied thereto, which moves the two ends towards each other and, thus, reduces the radius or the mean radius of the second contact region of the second element and presses the second contact region onto the first contact region so that partial melting is generated and the second element, after slowing down or stopping the rotation, is fixed to the first element almost over the entire first contact region. It is a matter of course that when the second element is to be pressed against the first element across the rotational axis, the second element may not be designed as a ring-shaped body or the second contact region may not be in ring form since otherwise the first element, which would be located in the recess of the ring-shaped body, could be brought into contact with the second element only at one side or at one half of the inner surface of the ring body. An exception to this might be possible if preferably a second element, in its heated state and, thus, in the thermally expanded state were put over the first element while the first element is held in rotation and the second element cools down, contracts and, thus, a tight fit and at the same time partial melting of the contact regions of the two elements may be caused and a bonded connection supporting the tight fit fixes the second element to the first element.

It is advantageous if the first end is shaped such that material accumulated in front of the first end during the rotation is guided into the space between the first and second contact regions. It may be particularly preferred that the first end of the second contact region is bevelled or chamfered or bevelled or chamfered such that material piled up in front of the first end is guided along the inclined edge below the second contact region and thus into the intermediate space between the second contact region and the first contact region. Material accumulates in front of the first end when the first end is directed against the direction of rotation of the first contact region so that material rubbed off or partially melted due to friction or material pressed out due to the contact force between the two elements accumulates bow-wave-like in front of the first end of the second contact region. Since it is in general not desirable that the accumulated material remains piled up in front of the first end after the end of the rotation, but is to be guided back into the welding zone between the first and second contact regions, the first end is designed or shaped such that the partially melted material will not permanently pile up in front of the first end but is permanently guided into the intermediate space between the first and second contact regions. Alternatively, it may also be preferred that the first end has a rounded or curved recess, wherein the rounding is such that the piled-up material at first meets the larger cross-section of the recess or rounding and from there is slowly narrowed to a smaller cross-section and subsequently gets into the gap between the first and second contact regions.

Advantageously, the second contact region has a mean radius of curvature, which is smaller than the radius of the first contact region so that when the elements are pressed against one another, at first the ends of the second contact region rub or grind against the first contact region, and wherein the area of partially melted material expands from the ends along the circumference of the second contact region. It is advantageous if the partial melting of the first and second contact regions at first takes place over a certain area only in order to keep as low as is possible the torques or kinetic energy required for achieving said partial melting, which energy in turn is transformed into thermal energy by means of friction. In particular, the mean radius in the case of a non-circular shape of the second contact region is designated as mean radius of curvature of the second contact region, wherein the second contact region may be designed elliptically or polygonally, for example. After the input of force has been started, which in turn causes the two elements to be pressed against one another, at first said first contact zone between the first and second contact regions is partially melted and removed over a certain area. Since the zone of partial melting preferably expands from the ends of the second contact region, finally the entire second contact region will be covered by a partially melted layer and rests against the first contact region. Alternatively preferably, when the mean radius of curvature of the second contact region is larger than the radius of the first contact region, at first the center of the second contact region may come into contact with the first contact region and the zone of partial melting may expand from the center up to the ends of the second contact region.

Preferably, the relationship of the mean radius of the second contact region to the radius of the first contact region is in the range of 0.8 to 0.99, preferably 0.9 to 0.98, and particularly preferably 0.95. The smaller the relationship of the mean radius of the second contact region to the radius of the first contact region, the larger the excess, which the first contact region has with respect to the opening left free by the second contact region, through which the first contact region or the first element across the rotational axis may be moved up to the second contact region of the second element. Furthermore, this relationship determines the amount of material to be melted-off or removed at first at the ends of the second contact region, before the entire second contact region meets the first contact region and partial melting occurs over the entire circumferential length of the second contact region.

In an alternatively preferred method, one of the contact regions is funnel-shaped and the respective other contact region is designed bevelled or chamfered rotationally symmetrically and/or designed rounded, wherein the first and second elements are pressed against one another along the rotational axis. The advantage of contact surfaces of the two contact regions designed such that they converge or diverge relative to each other may be used also for the axial rotational friction welding described in this embodiment with different words. Particularly preferably, the opening angle of the funnel-shaped opening or recess of one of the contact regions is larger or smaller than the angle of the chamfer or the mean angle of the rounding of the respective opposite contact region so that when the two elements are pressed against one another, at first a limited or line-shaped contact zone forms between the two elements, in which a first partial melting occurs. Alternatively preferably, also the funnel-shaped contact surface of one of the two contact regions may be designed rounded or ball-like. A great advantage, when the two elements are pressed against one another along the rotational axis, is that when only one of the two elements rotates and is displaced along its rotational axis, it may be joined with any corresponding geometry of the opposite element. Thus, for example, bent tube or axle assemblies may be produced and it is possible to weld further elements to elements already joined together.

Particularly preferably, before pressing the elements against one another, the second contact region comprises one or a plurality of contact projections. The contact projections, like a diverging or converging design of the contact surfaces of the first and second contact regions, serve to provide at first a contact between the two elements over a certain area only and, thus, at first partial melting of the materials of the first and second elements over a certain area only. The contact projections may have a trapezoidal, a rounded or a concave or convex shape, wherein the contact projections mainly serve to influence the flow properties of the partially melted material or to keep said partially melted material in the area of the zone of partial melting. It is further preferred that the contact projections are removed, rubbed off or melted away during welding so that, after welding has been completed, the material of the contact projections will be evenly distributed along the circumference of the first contact region and serves as welding material at the entire welded joint between the first and second elements.

Expediently, the contact projections project from the contact surface of the second contact region in the direction of the contact surface of the first contact region. It may be further preferred that the ends of the contact projections, which are opposed to the direction of rotation, are beveled, rounded or have a similar shape in order to guide material accumulated in front of the contact projection into the intermediate space between the contact projection and the first contact region and, thus, to return it to the zone of partial melting.

It is particularly preferred that the second element comprises a plurality of second contact regions which provide a first frictional contact with the first contact region in order to generate a first partial melting over a certain area between the first and second contact regions. It may be preferred, in particular when bending forces or torsion forces are to be transmitted from the first element to the second element, that the second element is connected to the first element via several spaced-apart contact points. Preferably, in case radial welding is used as method, i.e. the two parts are pressed against one another and welded together across the rotational axis or essentially across the rotational axis, there is provided a plurality of second contact regions or first contact regions, respectively, along the rotational axis, which are spaced apart, so that partial melting between the two elements is simultaneously achieved in several contact regions, which are distributed along the rotational axis between the first and second elements. It is further conceivable to weld the second element to the first element at any angle along or across the rotational axis and any angular degree therebetween, wherein the first contact region must have a contact surface, which is directed essentially perpendicular to the direction of pressure or to the direction of force while the two elements are pressed against one another so that in this way it is possible to fix to the first element also second elements which are directed not radially or perpendicularly or not axially.

In particular, it may also be preferred that the contact projections, which are provided at the second contact region or preferably also at the first contact region, are not completely removed during partial melting or welding so that after the rotation has been completed or after welding has been completed, the second element is fixed to the first element only in a certain area, i.e. in the area of the contact projections, and that there are gaps inbetween. This feature may in particular serve to reduce weight and to reduce the force or rotational power or rotational energy required for welding the two elements together.

It may be preferred that the circumference of the second contact region is smaller than half of the circumference of the first contact region. Due to this feature, which is particularly relevant when the two elements are pressed against each other across the rotational direction, the second element may be easily moved towards and fixed to the first element laterally, i.e. across the rotational direction. If the circumference of the second contact region were larger than half of the circumference of the first contact region, the second element or the second contact region would have to be put over the first element along the rotational axis or frontally and could be fixed thereto only afterwards.

Further according to the invention, there is provided an axle unit, in particular for commercial vehicles, comprising a first element and a second element, wherein the first element extends essentially along a rotational axis and comprises a first contact region which is designed rotationally symmetrically relative to the rotational axis, wherein the second element in a first state comprises a second contact region, and wherein the axle unit may be brought into a second state by means of a rotational friction welding method, in which state the first element at least over a certain area has a bonded connection with the second element in the first or second contact region. Thus, the axle unit is an assembly manufactured from a first and a second element by means of a rotational friction welding method and is used in particular for commercial vehicles, particularly preferably in the field of commercial vehicle chassis. The first element comprises a contact region which is essentially rotationally symmetric along a rotational axis, in which the second element is fixed to the first element.

Further advantages and features of the present invention become apparent from the following description of preferred embodiments of the axle unit according to the invention and of the method according to the invention for producing chassis components for commercial vehicles. Individual features of the various embodiments may be combined within the framework of the invention. Features pertaining to the axle unit may also be used for describing the method according to the invention in more detail.

### BRIEF DESCRIPTION OF THE DRAWINGS

FIG. 1 shows sectional views of a preferred embodiment of the axle unit according to the invention before applying the method in FIG. 1A and after forming the bonded connection in FIG. 1B,

FIG. 2 shows a sectional view of a preferred embodiment of the axle unit according to the invention in the state before forming the bonded connection,

FIG. 3 shows a sectional view of the first and second contact regions with preferred embodiments of the contact projection in the state before carrying out the method according to the invention for forming a bonded connection,

FIG. 4 shows a view of preferred embodiments of the first and of the second element in the state before applying the method according to the invention for fixing the two elements to each other, and

FIG. 5 shows a view of a preferred embodiment of the second element.

### DETAILED DESCRIPTION OF THE PREFERRED EMBODIMENTS

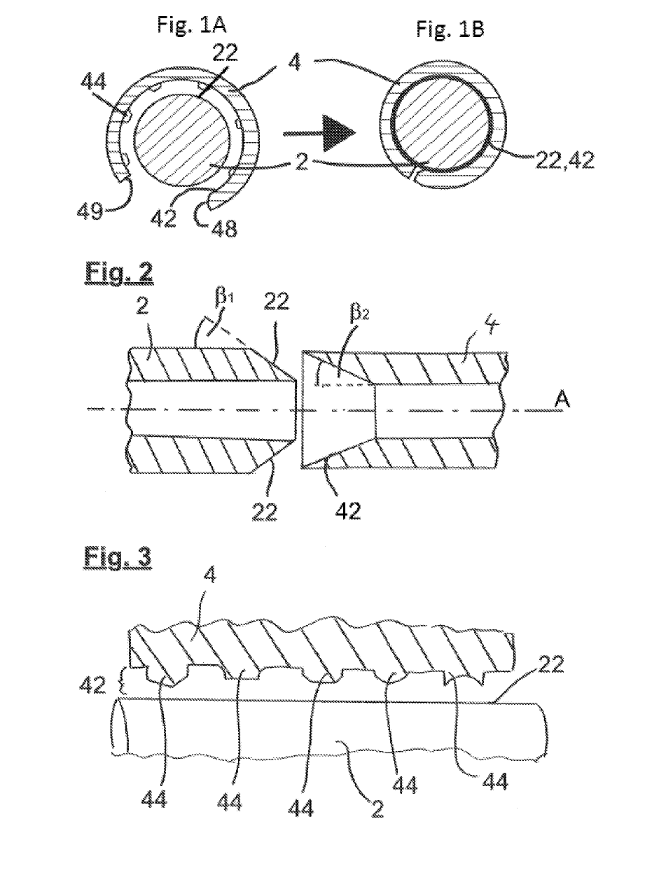

FIGS. 1A and 1B show sectional views of a preferred embodiment of the axle unit according to the invention in two states. FIG. 1A shows the first state, before carrying out the method according to the invention for producing chassis components for commercial vehicles. In this first state, there are provided a first element 2 and a second element 4. At the side opposite the first element 2, the second element 4 comprises a second contact region 42. According to the invention, said second contact region 42 is curved, preferably about at least one point located in the first element 2. As is shown in the Figure, the second element 4 preferably comprises a ring-shaped section or is designed ring-shaped in the sectional view, and surrounds the first element 2 at least over a certain area. In particular, as is shown in FIG. 1A, the mean radius of curvature of the second contact region 42 is larger than the radius of a first contact region 22 of the first element 2, so that when also the circumference of the second contact region 42 is larger than half of the circumference of the first contact region 22, the second element 4 may be put over the first element 2. Preferably, the second element 4 comprises two ends 48 and 49, wherein the first end 48 preferably comprises a bevelling or chamfer. Said bevelling or chamfer of the first end 48 of the second element 4 preferably serves to guide piled up material into the intermediate space between the first and second contact regions 22, 42. Preferably, the first end 48 may have a chamfer which is convexly or concavely rounded. Furthermore, the second contact region 42 preferably comprises at least one contact projection 44, which protrudes away from the second contact region 42 towards the first contact region 22. Preferably, there may be provided a number of contact projections 44 distributed over the second contact region 42, as is shown in FIG. 1A. In order to bring the first and second elements 2, 4 into the state shown in FIG. 1B, in which the first element 2 is fixed to the second element 4 by a bonded connection, there is used the method according to the invention for forming a bonded connection in order to fix chassis components. Here, the first and second elements 2, 4 are made to rotate relative to one another and then pressed against one another such that the first and second contact regions 22, 42 come into contact with each other and friction occurs. In the embodiment shown in the Figure, the direction of rotation of the two elements 2, 4 is preferably such that the second element 4 rotates with its first end 48 ahead relative to the first element 2 in order to make it possible to remove accumulated material by means of the chamfer of the first end 48. Preferably, the first element 2 may rotate, preferably in the counter-clockwise direction in the embodiment shown in the Figure, while the second element 4 is kept stationary. It is to be expected that in case only the first element 2, preferably the axle of a commercial vehicle, rotates, less machine outlay is required than for rotating an entire second element 4 extending further across the rotational axis A. Furthermore, according to the invention, the second element 4 is pressed against the first element 2, wherein in particular the two contact regions 22 and 42 are pressed against one another. In the preferred embodiment shown in the Figure, it is necessary to deform the second element 4 to this end, wherein the ends 48 and 49 thereof are displaced towards each other so that the mean radius of curvature R₂ is reduced until the contact projections 44 come into frictional contact with the first contact region 22. The temperature in the contact zone increases due to the friction between the contact projections 44 and the first contact region 22, in the case of sufficient pressure and rotational speed up to the melting temperature of the manufacturing material of the first element 2 and/or of the second element 4. At first, there is only local partial melting of the first and second contact regions 22, 42. Preferably, the contact projections 44 are hereby removed, the material melted away therefrom forms a zone of partially melted material surrounding the first contact region. When there is sufficient partial melting of the first and/or second contact region(s) 22, 42, the rotation of the elements 2, 4 relative to one another may be stopped, wherein the temperature in the zone of partial melting, which is shown in bold in FIG. 1B and designated by reference signs 22, 42, decreases since there is no more friction between the contact regions 22, 42, and the partially melted material solidifies. The result of the method is a bonded connection between the first and second elements 2, 4, made of a welding zone which is evenly distributed between the first and second elements 2, 4. The method described herein is preferably called radial rotational friction welding since the elements 2, 4 are pressed against one another essentially across the rotational axis.

FIG. 2 shows a first element 2 and a second element 4 in a state before carrying out the method according to the invention for joining chassis components. Here, the contact regions 22 and 42 of the elements 2 and 4 are designed such that they are displaced towards one another and pressed against one another along the rotational axis A. The first contact region 22 is preferably designed as lateral surface of a truncated cone, wherein the cutting edges of the lateral surface are inclined preferably at an angle β₁ relative to the rotational axis A. The second contact region 42 has a geometry which preferably corresponds at least over a certain area to the first contact region. As is shown in FIG. 2, the second contact region is preferably funnel-shaped, wherein the cutting edges of the inwards-facing surface of the second contact region 42 are inclined at an angle β₂ relative to the rotational axis A. Particularly preferably, β₁ and β₂ differ such that when the two contact regions meet, there is at first formed only a small contact stripe between the first and second elements 2, 4, which then expands further as the zone of partial melting progresses, until the first and second elements are connected to one another in a sufficiently large contact zone. The advantage of this contact between the two elements 2, 4 in an at first only small area is that the torque and pressure required for generating the corresponding thermal energy by friction between the elements 2, 4 may be kept low, since it is not the entire first contact region 22 that rubs or grinds against the second contact region 42. Furthermore, there is the possibility of exactly assessing the process flow by monitoring the progress of the partial melting. The design and arrangement of the elements 2 and 4 relative to one another as shown in FIG. 2 is preferably referred to as axial rotational friction welding since the elements 2, 4 which rotate relative to one another are essentially pressed against one another along the rotational axis A. Preferably, β₁ is larger than β₂, wherein in this case the partial melting of the contact regions 22 and 42 occurs from the left-hand side of the Figure. It may be further preferred that the first element 2 comprises a funnel-shaped first contact region 22 while the second element 4 comprises a second contact region 42 in the shape of a truncated cone. Further preferably, at least one of the two contact regions may comprise a rounded, concave or convex cross-sectional geometry, wherein the respective pairing of the geometries of the two contact regions 22, 42 may have an influence on the area of first contact between the elements 2, 4 and the temporal and spatial course of the expansion of the zone of partial melting.

FIG. 3 shows cross-sectional views of various preferred embodiments of the contact projection 44 provided in the second contact region 42 before carrying out the method according to the invention. Here, tapered or pointed, rectangular, trapezoidally rounded, positively curved or convex and/or negatively curved or concave cross-sectional shapes may be used. The cross-sectional shape of the contact projection 44 may influence in particular the area of first contact between the elements 2, 4 and the temporal and spatial course of the expansion of the zone of partial melting. For example, in the preferred concave cross-sectional shape of the contact projection 44, which is shown on the right-hand side in the Figure, partially melted material is guided into the space between the tapered or pointed ends of the contact projection, while in the course of the friction process the ends are preferably removed or melted away at least partially.

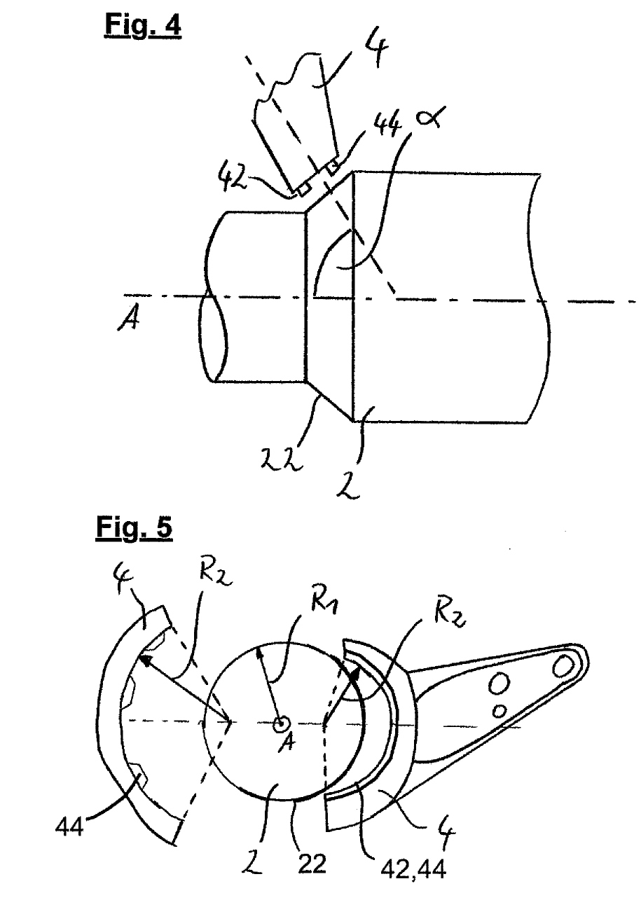

FIG. 4 shows a further preferred embodiment of the method according to the invention for fixing chassis components. Here, a second element 4 is displaced and pressed against a first element 2 along a direction inclined at an angle α relative to the rotational axis. Preferably, the second element 4 comprises contact projections 44 which come into contact with the first contact region 22, which in the cross-sectional view is directed perpendicular to the direction of displacement. An advantage of this embodiment is that a second element 4 may be joined in a bonded connection to a rotating element 2, which is designed rotationally symmetrically at least in a first contact region 22, also in cases where the second contact region 42 of the second element 4 is not designed rotationally symmetrically. Preferably, a plurality of second elements 4 may be fixed simultaneously to a first element 2, wherein the second elements 4 are preferably displaced radially and/or axially relative to one another. For a preferred angle α of 0°, the elements 2, 4 are thus pressed against one another along the rotational axis A so that the method is pure axial rotational friction welding. For a preferred angle α of 90°, thus, the elements 2, 4 are pressed against one another across the rotational axis A so that the method is radial rotational friction welding. The angle range between the two extremes of the angle α serves in particular to fix a second element 4, which is to transmit forces to the first element 2 in a certain direction, in exactly that direction to the first element 2.

Finally, FIG. 5 shows a view along the rotational axis A of two preferred embodiments of the first and second elements 2, 4 before carrying out the method according to the invention. Here, the second elements 4 shown each have a curved second contact region 42 with a radius of curvature R₂. The first element 2 is preferably designed circular in its first contact region 22 and has a radius R₁. The element 4 shown on the left-hand side in the Figure has a radius of curvature R₂, which is preferably larger than the radius R₁ of the first element 2. When said second element 4 is pressed against the first element 2, the first contact and, thus, the first partial melting will take place in the center of the second contact region 42, i.e. at the height of the horizontally drawn dashed line, and then expand to either end of the second contact region 42. The element 4 shown on the right-hand side in the Figure has a radius of curvature R₂, which is smaller than the radius R₁ of the first element 2. When said element 4 is pressed against the first element 2, a first contact and a first partial melting will take place at first at the ends of the second contact region 42 and then expand to the center of the second contact region 42.

### LIST OF REFERENCE SIGNS

2—first element
4—second element
22—first contact region
42—second contact region
44—contact projection
48—first end of the second contact region
49—second end of the second contact region
A—rotational axis
α—contact angle rel. to A
β₁—angle first contact region
β₂—angle second contact region
R₁—radius of the first contact region
R₂—mean radius of the second contact region

1-10. (canceled)

11. A method for producing chassis components for commercial vehicles, comprising the following steps:
providing a first element and a second element, wherein the first element has a first contact region that is substantially rotationally symmetrically about a rotational axis, and wherein the second element has a second contact region which is curved and arranged opposite the first contact region;
causing one of the first and second elements to rotate about the rotational axis relative to the other first and second element;
pressing the first and second elements against one another such as to generate friction between the second contact region and the first contact region and partial melting in the first and second contact regions; and
delaying the rotation of the first and second elements relative to one another, wherein the partially melted regions transition into a solid state and a bonded connection is established between the first element and the second element.

12. The method of claim 11, wherein the first contact region and the second contact region have contact surfaces, which before being pressed against one another are aligned such that they lie opposite one another and are designed such that they diverge or converge relative to one another.

13. The method of claim 12, wherein the first and second elements are pressed against one another across the rotational axis and wherein the second element has a first end and a second end along a circumferential direction of the second element.

14. The method of claim 13, wherein the first end is formed such that material accumulated in front of the first end during the rotation is guided into a space between the first and second contact regions.

15. The method of claim 14, wherein the second contact region has a mean radius of curvature, which is smaller than the radius of the first contact region so that when pressing the elements against one another, at first the ends of the second contact region grind or rub against the first contact region, and wherein the area of partially melted material expands from the ends along the circumference of the second contact region.

16. The method of claim 15, wherein the relationship of the mean radius of the second contact region to the radius of the first contact region is in the range of about 0.8 to about 0.99.

17. The method of claim 16, wherein the relationship of the mean radius of the second contact region to the radius of the first contact region is in the range of 0.9 to 0.98.

18. The method of claim 17, wherein the relationship of the mean radius of the second contact region to the radius of the first contact region is 0.95.

19. The method of claim 11, wherein one of the contact regions is funnel-shaped and the respective other contact region is one of beveled, chamfered rotationally symmetrically, and rounded, and wherein the first and second elements are pressed against one another along the rotational axis.

20. The method of claim 11, wherein before pressing the elements against one another, the second contact region comprises at least one contact projection.

21. The method of claim 11, wherein the second element comprises a plurality of second contact regions, which provide a first friction contact with the first contact region in order to generate over a certain area a first partial melting between the first and second contact regions.

22. An axle unit for commercial vehicles, comprising:
a first element and a second element;
wherein the first element extends substantially along a rotational axis and comprises a first contact region, which is designed rotationally symmetrically relative to the rotational axis;
wherein in a first state the second element comprises a second contact region; and
wherein the axle unit may be brought into a second state by a rotational friction welding method, in which state the first element at least over a certain area has a bonded connection with the second element in the at least one of the first contact region and the second contact region.

23. The method of claim 11, wherein the first and second elements are pressed against one another across the rotational axis, and wherein the second element has a first end and a second end along a circumferential direction of the second element.

24. The method of claim 23, wherein the first end is formed such that material accumulated in front of the first end during the rotation is guided into a space between the first and second regions.

25. The method of claim 23, wherein the second contact region has a mean radius of curvature which is smaller than the radius of the first contact region so that when pressing the elements against one another, at first the ends of the second contact region grind or rub against the first contact region, and wherein the area of partially melted material expands from the ends along the circumference of the second contact region.

26. The method of claim 25, wherein the relationship of the mean radius of the second contact region to the radius of the first contact region is in the range of about 0.8 to about 0.99.

27. The method of claim 26, wherein the relationship of the mean radius of the second contact region to the radius of the first contact region is in the range of 0.9 to 0.98.

28. The method of claim 27, wherein the relationship of the mean radius of the second contact region to the radius of the first contact region is 0.95.
